(19) United States
(12) Patent Application Publication
(10) Pub. No.: US 2006/0062453 A1
(43) Pub. Date: Mar. 23, 2006

(54) Color highlighting document image processing

(75) Inventor: Bryan Keith Schacht, Laguna Beach, CA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/948,821

(22) Filed: Sep. 23, 2004

(51) Int. Cl. G06K 9/34

(52) U.S. Cl. 382/164

(57) ABSTRACT

A system and method are provided for processing a document image using color highlighting. The method comprises: scanning a document, creating a document image; searching the document image for a color-highlighted area; processing the document image with optical character recognition (OCR), creating a text document; identifying a text phrase associated with the color-highlighted area; searching the text document for the identified text phrase; and, tracking each area in the document image associated with the identified text phrase. Searching the document image for a color-highlighted area includes supplying a coordinate associated with the color-highlighted area. A text phrase in the text document is identified in response to locating the text phrase at the color-highlighted area coordinates. Tracking each area in the document image associated with the identified text phrase includes: tracking the coordinates of each identified text phrase in the text document; and, transposing the coordinates to the document image.

### BACKGROUND OF THE INVENTION

1. Field of the Invention

This invention generally relates to digital image processing and, more particularly, to a system and method that determines a phrase associated with a color-highlighted area of the document, and automatically locates and marks other instances of the phrase in the document.

2. Description of the Related Art

The use of color highlighting recognition, for use with scanned documents, is becoming more prevalent. Likewise, it is now possible to print color documents at lower costs than in the past. However, there are a limited number of digital document processes that take advantage of color scanning features, or that recognize that documents are now often printed in color.

Conventionally, if a person wants to highlight similar terms on an original printed document, they must manually read each page, find the similar terms, and highlight them. This can be a tedious process, especially with long documents, and terms can easily be missed.

It would be advantageous if the color processing capabilities of digital document devices could be maximized.

It would be advantageous if a digital document process, such as a word search or administrative operation, could be initiated by using color to highlight an area of a hardcopy document.

It would be advantageous if the above-mentioned color highlighting process could be used to reduce the man-hours associated with printing, archiving, or communicating a document.

### SUMMARY OF THE INVENTION

A system and method are provided that permit a user to highlight one or more terms on an original paper, and scan the document. An imaging device, such as a multifunctional peripheral (MFP), or a networked server, scans the document in color and recognizes whether the page contains color highlights over text, using image segmentation. Then, the entire set of scanned pages is run through a text recognition process (OCR), which can be on a networked server, or contacted through a web service directly from the MFP. Secondary processing recognizes words that are highlighted in appropriate colors (keywords). These keywords are located in response to searching the text of an OCR processed document. The terms or keywords are located in the remainder of the document, and associated with the same color highlighting that was initially applied to the original paper. Finally, a document, with the additional highlights, is printed by the MFP, emailed, or saved in image or text format facilitating reuse via common document formats like PDF.

This color highlighting technique can also be used for redaction of documents. A color highlight can be used to search for similar terms and then apply blackout redaction to the original through a slight modification to the process. The specific process and desired output may be selected prior to the scanning.

Accordingly, a method is provided for processing a document image using color highlighting. The method comprises: scanning a document, creating a document image; searching the document image for a color-highlighted area; processing the document image with optical character recognition (OCR), creating a text document; identifying a text phrase associated with the color-highlighted area; searching the text document for the identified text phrase; and, tracking each area in the document image associated with the identified text phrase.

Searching the document image for a color-highlighted area includes supplying a coordinate associated with the color-highlighted area. A text phrase in the text document is identified as being associated with the color-highlighted area in response to locating the text phrase at the color-highlighted area coordinates. Tracking each area in the document image associated with the identified text phrase includes: tracking the coordinates of each identified text phrase in the text document; and, transposing the coordinates to the document image.

In one aspect, a highlighted document is printed with markings in the tracked areas, following the transposing of the coordinates to the document image. For example, a print engine may generate a document image, temporarily store the document image, and overlay markings on the stored image corresponding to the transposed coordinates in the document image. Alternately, image markings are created in regions of the document image corresponding to the transposed coordinates, creating a marked document image. Then, the marked document image can be printed.

Tracking each area in the document image associated with the identified text phrase includes using a marking such as color highlighting, redacting, and text highlighting using font, bold, italics, or underling. For example, if the original document includes a phrase marked in yellow, each tracked occurrence of the phrase in the printed document could also be marked in yellow.

Additional details of the above-described method and a system for processing a document image using color highlighting are presented below.

### BRIEF DESCRIPTION OF THE DRAWINGS

FIG. 1 is a schematic block diagram of a system for processing a document image using color highlighting.

FIG. 2 is a diagram illustrating an exemplary use of the system of FIG. 1.

FIGS. 3A and 3B are flowcharts illustrating a method for processing a document image using color highlighting.

FIGS. 4A and 4B illustrate an exemplary highlighting process.

### DETAILED DESCRIPTION OF THE PREFERRED EMBODIMENTS

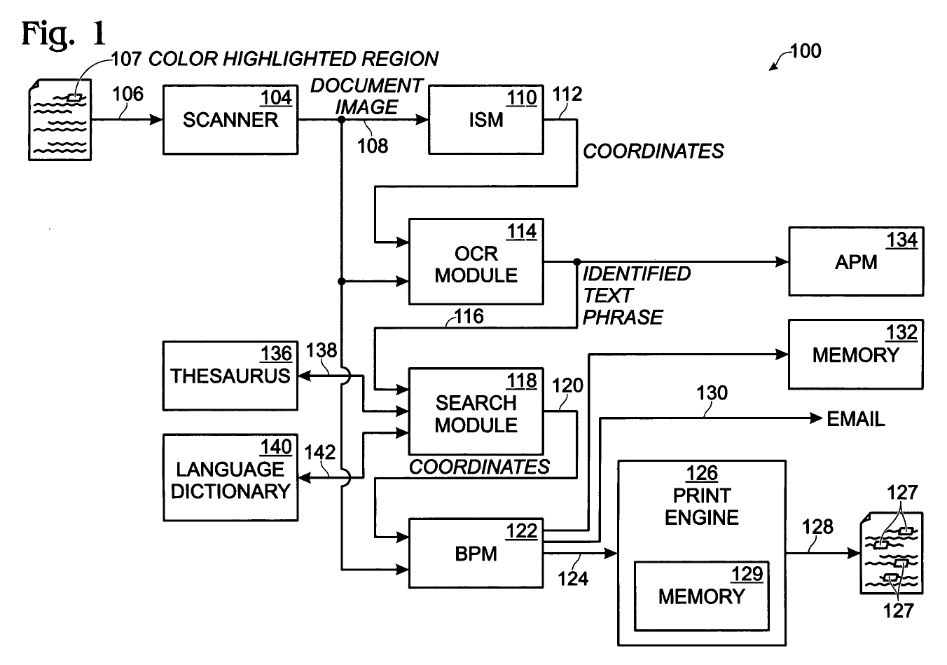

FIG. 1 is a schematic block diagram of a system for processing a document image using color highlighting. The system 100 comprises a scanner 104 having an interface on line 106 to accept a document with a color-highlighted region 107, and an interface on line 108 to supply a document image in response to scanning the document. The scanner 104 may be an element of an MFP, copier, printer-enabled copier, or fax machine, to name a few examples. The document accepted on line 106 is typically a hardcopy document printed on paper. However, the document may be printed on other physical media. The document image supplied on line 108 can be raster data or a bitmap.

An image segmentation module (ISM) 110 has an interface on line 108 to accept to the document image. The ISM 110 has an interface on line 112 to supply coordinates in response to searching the document image for the color-highlighted areas. An optical character recognition (OCR) module 114 has an interface on line 108 to accept the document image and an interface on line 112 to accept the color-highlighted area coordinates. The OCR module 114 creates a text document from the document image and supplies the text document and a text phrase, identified in the text document as being associated with the color-highlighted area coordinates, at an interface on line 116.

A search module 118 has an interface to accept the text document and the identified text phrase on line 116. The search module 118 searches the text document for the identified text phrase and supplies coordinates for the location of each identified text phrase at an interface on line 120. A bitmap processing module (BPM) 122 has an interface on line 108 to accept the document image, and an interface on line 120 to accept the identified text phrase coordinates. The BPM 122 supplies a document image tracking each area associated with the identified text phrase coordinates on line 124. That is, the bitmap processing module 122 transposes identified text phrase coordinates in the text document into coordinates in the document image.

The bitmap processing module 122 tracks each area associated with the identified text phrase coordinates by using a marking such as color highlighting, redacting, and text highlighting using font, bold, italics, or underling to name a few examples. There are other conventional forms of marking that can be used to draw a reader's attention to certain areas of a document that can be used to help enable the system. Note, at this stage in the process, the “markings” are in an electronic form.

For example, the image segmentation module 110 may search the document image for an area highlighted in a first color (i.e., yellow). A text phrase, i.e., “profit”, is identified in the first color-highlighted area. The bitmap processing module 122 tracks each area associated with the identified text phrase coordinates by marking the tracked areas with the yellow (first) color. Alternately, the BPM 122 can mark the tracked areas using a means other than color, for example, the tracked areas can be marked by underlying. That is, the BPM 122 underlines or color-marks each instance of the word “profit”.

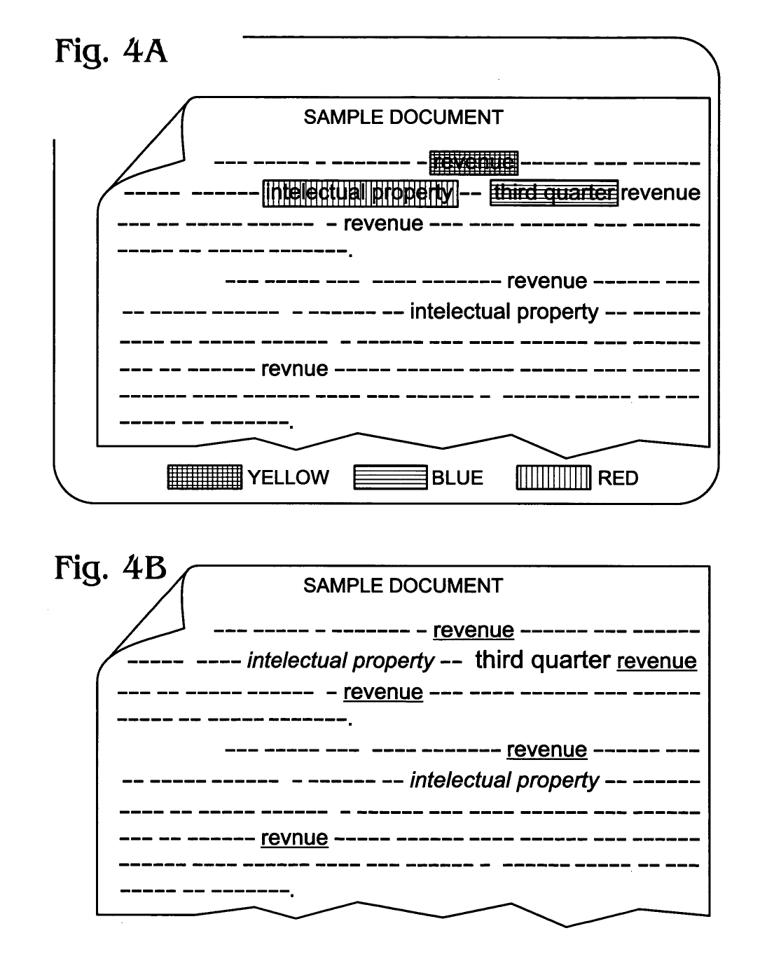

FIGS. 4A and 4B illustrate an exemplary highlighting process. In this example, the image segmentation module 110 searches for a plurality of areas highlighted with a corresponding plurality of different colors and supplies a coordinate associated with each color. For example, the ISM 110 supplies coordinates for 3 areas in a document, one area marked in yellow, a second in blue, and a third in red, see FIG. 4A. In FIG. 4A the dashed lines are intended to represent text. The OCR module 114 identifies a particular text phrase associated with each coordinate. For example, the OCR module identifies the phrases “revenue” with a first coordinate, “third quarter” with the second coordinate, and “intellectual property” with a third coordinate. The search module 118 searches for each particular text phrase, and supplies groups of coordinates for each particular text phrase. For example, the search module supplies coordinates for each of five occurrences of the word “revenue”. The bitmap processing module 122 independently tracks areas associated with each coordinate group. That is, the BPM 122 tracks the coordinates associated with the word “revenue” independently of the coordinates associated with the phrases “intellectual property” and “third quarter”. This independent tracking permits the word groups to be marked differently. For example, each occurrence of the word “revenue” can be marked in yellow, while each occurrence of the phrase “third quarter” can be marked in blue. Alternately as shown in FIG. 4B, the word “revenue” is underlined, the phrase “intellectual property” is italicized, and the phrase “third quarter” is marked in a larger font.

The system 100 may further comprises a print engine 126 having an interface on line 124 to accept the document image from the bitmap processing module. The print engine 126 has an interface on line 128 to supply a printed highlighted document with markings 127 in the tracked areas. In one aspect, the print engine 126 prints the highlighted document as a two or three-step operation. The print engine generates the document image to be printed, stores the document image in memory 129. Note, in some aspects the print engine receives the document image in a ready-to-print format. Then, the print engine 126 overlays markings in regions corresponding to the transposed coordinates in the document image, onto the document image in memory 129, prior to printing. That is, the print engine 126 generates a marked document image.

In a different aspect, the bitmap processing module 122 creates the marked document image with image markings in regions of the document image corresponding to the transposed coordinates. Then, the marked document image can be printed at print engine 126. That is, the marking process is transparent to the print engine 126.

In one aspect, the bitmap processing module 122 converts the marked document image into an image format such as tagged image format (TIFF or TIF) or portable document format (PDF). However, the system is not limited to any particular format. Then, the converted marked document can be emailed on line 130, or filed in memory 132.

In another aspect the system further comprises an auxiliary processing module (APM) 134 having an interface on line 116 to accept the text document and the identified text phrase. The auxiliary processing module 134 performs a process such as identifying an address in the text document, calculating the number of identified text phrase occurrences, automatically creating an index for identified text phrases, initiating a search for stored documents associated with the identified text phrase, sending a highlighted document image to an identified address in the document image, or filing a highlighted document image in a folder associated with the identified text phrase.

In a different aspect the system further comprises an electronically formatted thesaurus 136 accessible on line 138. The search module 118 accesses the thesaurus 136 for terms similar to the identified text phrase, searches the text document for the identified similar terms, and additionally supplies coordinates associated with identified similar terms. For example, the search module 118 may initiate a search for terms similar to “revenue”, and may choose to additionally highlight terms such as “income” and “cash”.

In one aspect the system further comprises an electronically formatted language translation dictionary 140 accessible on line 142. The search module 118 accesses the dictionary 140 for a translation of the identified text phrase, searches the text document for the identified translation term, and additionally supplies coordinates for identified translation terms. For example, the search module 118 may additionally highlight the German translation for the term “revenue”.

Several of the above-mentioned system elements may be enabled as a set of software instructions that can be stored in memory and manipulated by a microprocessor. However, other elements, such as the print engine and scanner, include at least some machinery. In some aspects, all the above-mentioned elements can reside in a common device, an MFP for example. However, the elements may also reside in network or locally-connected devices.

### Functional Description

The above-described system builds upon, and uniquely combines some conventional technologies. Image segmentation is a process of locating regions on images based on analysis. This technology is commonly used in compression techniques like mixed-raster, to compress color regions differently from monochrome regions. A mixed raster compression (MRC) formatted document may result from processing using segmentation and recompressing into a file type with some monochrome compression, and some color compression for example. The system also builds upon a process of OCR text recognition, used after segmentation.

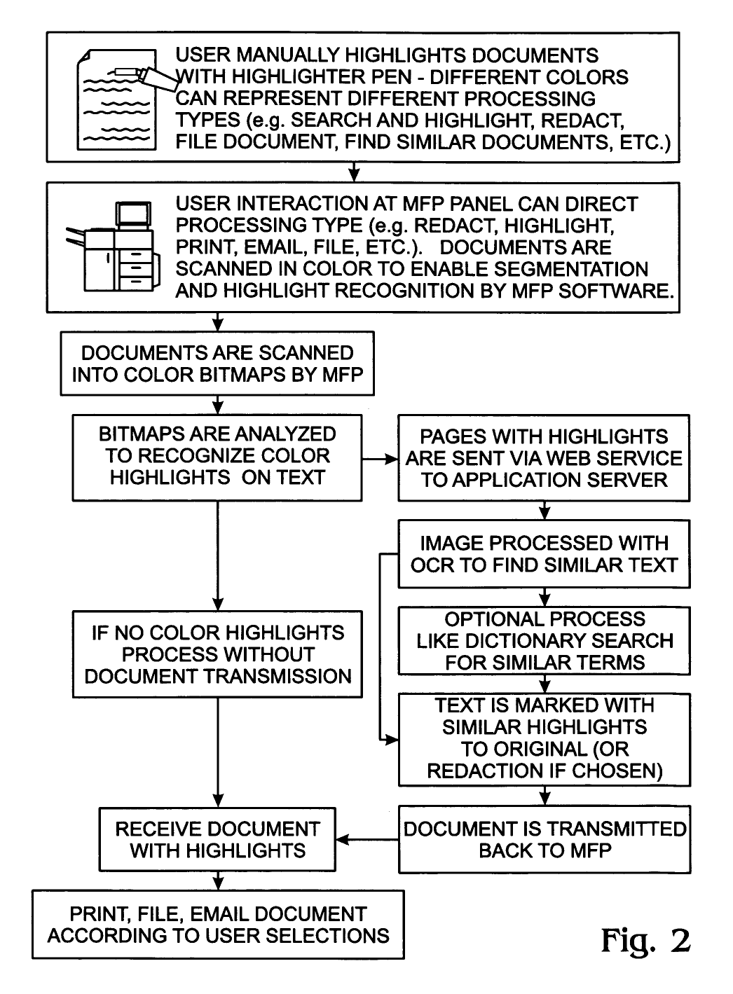

FIG. 2 is a diagram illustrating an exemplary use of the system of FIG. 1. In summary, the system applies segmentation to the image, in combination with OCR and text searching, with the application of highlights to similar recognized terms in the same color highlight as the original. In addition to the basic process summarized in FIG. 2, the system can be configured so that the highlighted terms trigger certain processes like approval cycles for the document, concordance listings of keyword frequency, or automatic index creation by highlighted terms, to name a few examples.

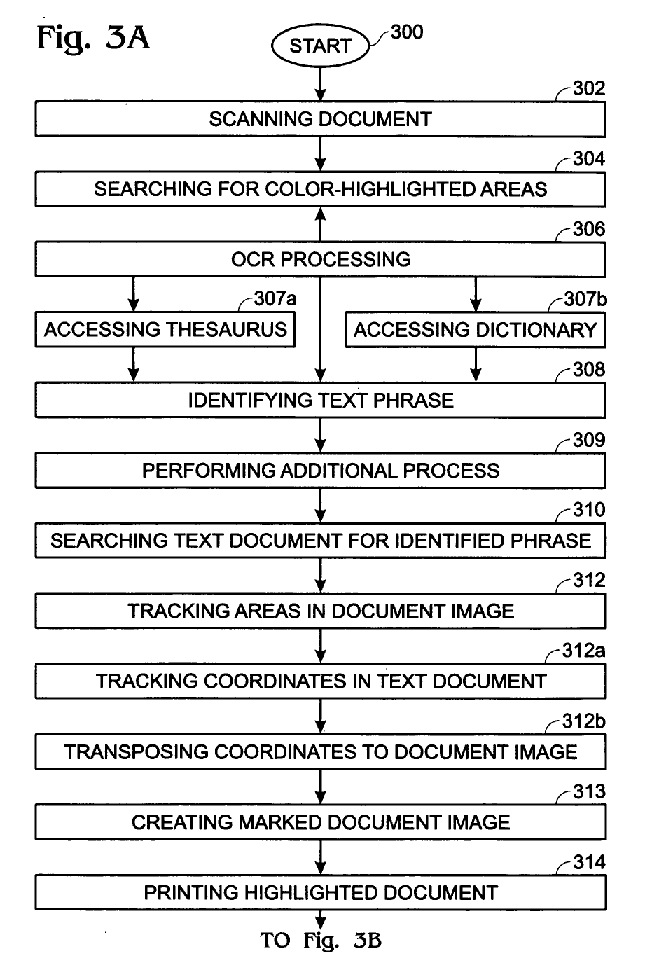

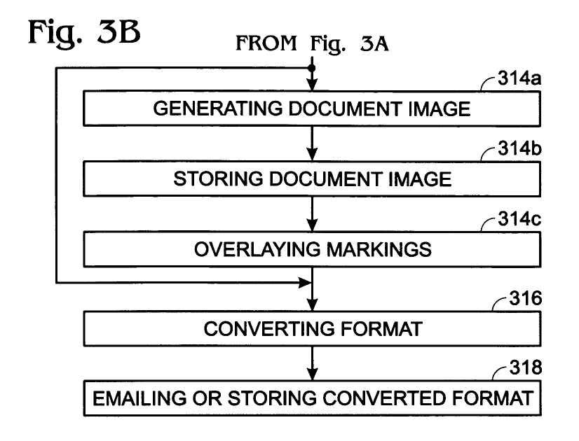

FIGS. 3A and 3B are flowcharts illustrating a method for processing a document image using color highlighting. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 300.

Step 302 scans a document, creating a document image. Step 304 searches the document image for a color-highlighted area. For example, Step 304 may use an image segmentation process to search for the color-highlighted area. Step 306 processes the document image with optical character recognition (OCR), creating a text document. Step 308 identifies a text phrase associated with the color-highlighted area. For example, Step 308 may identify the text phrase in the text document associated with the color-highlighted area. Step 310 searches the text document for the identified text phrase. Step 312 tracks each area in the document image associated with the identified text phrase.

Step 312 may track each area in the document image associated with the identified text phrase using a marking such as color highlighting, redacting, and text highlighting using font, bold, italics, or underling. In one example of the method, Step 304 searches the document image for an area highlighted in a first color. Then, Step 312 marks the tracked areas with the first color. Alternately, Step 312 may mark the tracked areas with a color other than the first color.

In another example, Step 304 searches for a plurality of areas highlighted with a corresponding plurality of different colors. For example, a yellow area associated with the word “revenue” and a blue area associated with the phrase “third quarter”. Identifying a text phrase associated with the color-highlighted area in Step 308 includes identifying a particular text phrase with each color. Then, tracking each area in the document image associated with the identified text phrase in Step 312 includes independently tracking areas associated with each text phrase.

In one aspect, searching the document image for a color-highlighted area in Step 304 includes supplying a coordinate associated with the color-highlighted area. Then, identifying a text phrase in the text document associated with the color-highlighted area in Step 308 includes identifying a text phrase in the text document corresponding to the color-highlighted area coordinates.

In another aspect, tracking each area in the document image associated with the identified text phrase in Step 312 includes substeps. Step 312a tracks the coordinates of each identified text phrase in the text document. Step 312b transposes the coordinates to the document image.

In a different aspect, following the transposing of the coordinates to the document image (Step 312b), Step 314 prints a highlighted document with markings in the tracked areas. For example, Step 314 may include substeps. Step 314a generates the document image at the printer. Alternately, the document image is received in a printer-ready format. Step 314b stores the document image in printer memory. Step 314c overlays markings, in regions corresponding to the transposed coordinates in the document image, onto the document image in memory prior to printing.

Alternately, Step 313 creates image markings in regions of the document image corresponding to the transposed coordinates, creating a marked document image. Then, Step 314 prints the marked document image as a highlighted document.

In another aspect, Step 316 converts the marked document image into an image format such as TIF or PDF. Then, Step 318 either emails the converted document or files the converted document in memory. Other operations are also possible to perform using the converted format document.

In a different aspect Step 309, following the searching of the OCR processed document for the identified text phrase (Step 308), performs a process such as identifying an address in the text document, sending the marked document image to an identified address in the document image, calculating the number of identified text phrase occurrences, automatically creating an index for identified text phrases, filing the marked document image in a folder associated with the identified text phrase, or initiating a search for stored documents associated with the identified text phrase.

In another aspect Step 307a accesses a thesaurus for terms similar to the identified text phrase. Then, Step 308 additionally searches the text document for the identified similar terms, and Step 312 additionally tracks areas in the document image associated with identified similar terms.

Alternately, Step 307b accesses a language translation dictionary for a term associated with the identified text phrase. Then, Step 308 additionally searches the text document for the identified translated term, and Step 312 additionally tracks areas in the document image associated with the translated term.

A system and method have been provided for marking terms in a document in response to initially identifying a term associated with a color-highlighted region, and tracking each instance of the identified term in the document. A few examples of initial color highlighting means have been presented, but the invention is not limited to just these examples. For example, the invention might be used to initially identify other kinds of markings, such as circles or underlines. Further, the invention can be extended to identify images, logos, signatures, and the like, as well as just words. Examples have also been given of the manner in which the final document might be marked, after all the terms have been located. Again, the invention is not limited to merely these examples. Other variations and embodiments of the invention will occur to those skilled in the art.

We claim:

1. A method for processing a document image using color highlighting, the method comprising:
scanning a document, creating a document image;
searching the document image for a color-highlighted area;
identifying a text phrase associated with the color-highlighted area; and,
tracking each area in the document image associated with the identified text phrase.

2. The method of claim 1 further comprising:
processing the document image with optical character recognition (OCR), creating a text document;
wherein identifying a text phrase associated with the color-highlighted area includes identifying the text phrase in the text document associated with the color-highlighted area; and,
the method further comprising:
searching the text document for the identified text phrase.

3. The method of claim 2 wherein searching the document image for a color-highlighted area includes supplying a coordinate associated with the color-highlighted area; and,
wherein identifying a text phrase in the text document associated with the color-highlighted area includes identifying a text phrase in the text document corresponding to the color-highlighted area coordinates.

4. The method of claim 3 wherein tracking each area in the document image associated with the identified text phrase includes:
tracking the coordinates of each identified text phrase in the text document; and,
transposing the coordinates to the document image.

5. The method of claim 4 further comprising:
following the transposing of the coordinates to the document image, printing a highlighted document with markings in the tracked areas.

6. The method of claim 5 wherein printing the highlighted document with markings in the tracked areas includes:
generating the document image at the printer;
storing the document image in printer memory; and,
overlaying markings, in regions corresponding to the transposed coordinates in the document image, onto the document image in memory prior to printing.

7. The method of claim 1 wherein tracking each area in the document image associated with the identified text phrase includes using a marking selected from the group including color highlighting, redacting, and text highlighting using font, bold, italics, and underling.

8. The method of claim 1 wherein searching the document image for the color-highlighted area includes searching for an area highlighted in a first color; and,
wherein tracking each area in the document image associated with the identified text phrase includes marking the tracked areas with the first color.

9. The method of claim 4 further comprising:
creating image markings in regions of the document image corresponding to the transposed coordinates, creating a marked document image.

10. The method of claim 9 further comprising:
converting the marked document image into an image format selected from the group including TIF and PDF; and,
performing a process selected from the group including emailing the converted document and filing the converted document in memory.

11. The method of claim 9 further comprising:
printing the marked document image as a highlighted document.

12. The method of claim 1 wherein searching the document image for the color-highlighted area includes searching for a plurality of areas highlighted with a corresponding plurality of different colors;
wherein identifying a text phrase associated with the color-highlighted area includes identifying a particular text phrase with each color; and,
wherein tracking each area in the document image associated with the identified text phrase includes independently tracking areas associated with each text phrase.

13. The method of claim 1 wherein searching the document image for the color-highlighted area includes using an image segmentation process to search for the color-highlighted area.

14. The method of claim 2 further comprising:
following the searching of the OCR processed document for the identified text phrase, performing a process selected from the group including identifying an address in the text document, sending the marked document image to an identified address in the document image, calculating the number of identified text phrase occurrences, automatically creating an index for identified text phrases, filing the marked document image in a folder associated with the identified text phrase, and initiating a search for stored documents associated with the identified text phrase.

15. The method of claim 2 further comprising:
accessing a thesaurus for terms similar to the identified text phrase;
wherein searching the text document for the identified text phrase includes searching the text document for the identified similar terms; and,
wherein tracking each area in the document image associated with the identified text phrase includes additionally tracking areas in the document image associated with identified similar terms.

16. The method of claim 2 further comprising:
accessing a language translation dictionary for a term associated with the identified text phrase;
wherein searching the text document for the identified text phrase includes searching the text document for the identified translated term; and,
wherein tracking each area in the document image associated with the identified text phrase includes additionally tracking areas in the document image associated with the translated term.

17. A system for processing a document image using color highlighting, the system comprising:
a scanner having an interface to accept a document and an interface to supply a document image in response to scanning the document;
an image segmentation module having an interface to accept the document image and to supply coordinates in response to searching the document image for the color-highlighted areas;
an optical character recognition (OCR) module having an interface to accept the document image and the color-highlighted area coordinates, the OCR module creating a text document from the document image and supplying the text document and a text phrase, identified in the text document as being associated with the color-highlighted area coordinates, at an interface;
a search module having an interface to accept the text document and the identified text phrase, the search module searching the text document for the identified text phrase and supplying coordinates for the location of each identified text phrase at an interface; and,
a bitmap processing module having an interface to accept the document image and the identified text phrase coordinates, and to supply a document image tracking each area associated with the identified text phrase coordinates.

18. The system of claim 17 wherein the bitmap processing module transposes identified text phrase coordinates in the text document into coordinates in the document image.

19. The system of claim 18 further comprising:
a print engine having an interface to accept the document image from the bitmap processing module and an interface to supply a printed highlighted document with markings in the tracked areas.

20. The system of claim 19 wherein the print engine prints the highlighted document as follows:
generating the document image to be printed;
storing the document image to be printed; and,
overlaying markings, in regions corresponding to the transposed coordinates in the document image, onto the document image in memory prior to printing.

21. The system of claim 18 wherein the bitmap processing module creates a marked document image with image markings in regions of the document image corresponding to the transposed coordinates.

22. The system of claim 18 wherein the bitmap processing module tracks each area associated with the identified text phrase coordinates by using a marking selected from the group including color highlighting, redacting, and text highlighting using font, bold, italics, and underling.

23. The system of claim 18 wherein the image segmentation module searches the document image for an area highlighted in a first color; and,
wherein the bitmap processing module tracks each area associated with the identified text phrase coordinates by marking the tracked areas with the first color.

24. The system of claim 18 wherein the bitmap processing module creates a marked document image with image markings in regions of the document image corresponding to the transposed coordinates, converts the marked document image into an image format selected from the group including TIF and PDF, and performs a process selected from the group including emailing the converted document and filing the converted document in memory.

25. The system of claim 17 wherein the image segmentation module searches for a plurality of areas highlighted with a corresponding plurality of different colors and supplies a coordinate associated with each color;
wherein the OCR module identifies a particular text phrase associated with each coordinate;
wherein the search module searches for each particular text phrase, and supplies groups of coordinates for each particular text phrase; and,
wherein the bitmap processing module independently tracks areas associated with each coordinate group.

26. The system of claim 17 further comprising:
an auxiliary processing module having an interface to accept the text document and the identified text phrase, the auxiliary processing module performing a process selected from the group including identifying an address in the text document, calculating the number of identified text phrase occurrences, automatically creating an index for identified text phrases, initiating a search for stored documents associated with the identified text phrase, sending a highlighted document image to an identified address in the document image, and filing a highlighted document image in a folder associated with the identified text phrase.

27. The system of claim 17 further comprising:
an accessible, electronically formatted thesaurus; and,
wherein the search module accesses the thesaurus for terms similar to the identified text phrase, searches the text document for the identified similar terms, and additionally supplies coordinates associated with identified similar terms.

28. The system of claim 17 further comprising:
an accessible, electronically formatted language translation dictionary;
wherein the search module accesses the dictionary for a translation of the identified text phrase, searches the text document for the identified translation term, and additionally supplies coordinates for identified translation terms.
